(19) United States
(12) Patent Application Publication
(10) Pub. No.: US 2023/0364624 A1
(43) Pub. Date: Nov. 16, 2023

(54) ONE PIECE SPRAY CLEANING NOZZLE

(71) Applicant: DLHBOWLES, INC., Canton, OH (US)

(72) Inventors: Chunling Zhao, Ellicott City, MD (US); Robert Kasson, Ellicott City, MD (US)

(21) Appl. No.: 18/196,673

(22) Filed: May 12, 2023

Related U.S. Application Data
(60) Provisional application No. 63/340,961, filed on May 12, 2022.

(51) Int. Cl. B05B 1/04; B08B 3/02

(52) U.S. Cl. CPC B05B 1/046; B08B 3/02; B60S 1/56

(57) ABSTRACT

Disclosed is a shear type fluid spray nozzle having a small size for use on a vehicle to produce a desired shear spray that includes a body made from one piece of material that defines an inlet, a cavity, and an outlet. In an embodiment, the cavity may be aligned along an inlet axis and the outlet is aligned along an outlet axis that is generally transverse to the inlet axis. The geometry of the fluid spray nozzle may act to separate a main flow of fluid within the cavity to maintain the spray aim and spray fan shape at a desirable condition.

### CROSS REFERENCE TO RELATED APPLICATIONS

This application claims priority to U.S. provisional patent application Ser. No. 63/340,961 filed on May 12, 2022, which is incorporated by reference.

### FIELD OF THE DISCLOSURE

The disclosure relates to a fluid nozzle and, more particularly, a fluid nozzle having a low-profile, one-piece design that can provide controlled spray performance.

### BACKGROUND OF THE DISCLOSURE

Some vehicles include external sensors, including external view (e.g., front bumper, side-view, rear-view or back-up) cameras to enhance the driver's vision and to improve safety. For example, rearview or “back-up” camera systems may be integrated into vehicles to minimize the likelihood of “backovers.” A backover is a specifically-defined type of accident, in which a non-occupant of a vehicle (e.g., a pedestrian or cyclist) or other object is struck by a vehicle moving in reverse. Vehicles can include other cameras to see into any other blind spot or desired area around a vehicle's periphery (behind, to the side, in front, above).

Increasingly, a wide range of cars and SUVs include a number of integrated video cameras and sensors (e.g., IR imaging, LiDAR, etc.) to generate images for display within the vehicle's interior and to allow drivers/operators to see whether obstacles surround their vehicle using a display screen mounted either on a rear view mirror or in a navigation system screen, for example. As another example, outdoor safety cameras and sensing devices (both fixed and moveable) are used for similar purposes and encounter similar issues to those encountered by vehicle sensors. Typically, these cameras and sensing devices include one or more exterior lens surfaces which can eventually become soiled with environmental debris, such as road grime, dirt, water spots, and the like, which can impair use and functionality of the cameras.

Many vehicles and safety systems now also use in cameras and/or sensors in more sophisticated automated assistance features, such as driver assistance systems, electronic power assist steering, lane keeping assistance, adaptive cruise control, adaptive steering, blind spot detection, parking assistance, traction, and brake control. The various types of automation also rely on sensor input for their control and functionality. As above, portions of the sensors can also become soiled with environmental debris, such as road grime, dirt, water spots, and the like, which can impact the control and functionality of the sensors.

When excessive amounts of debris accumulate on the lens and/or other portions of the cameras and sensors, it becomes difficult to access and clean them manually. Such debris also distorts images, deteriorates accuracy of automated systems, and in some cases even renders sensor output and the automated systems relying upon those sensors unusable. Therefore, apparatus for regularly cleaning the lens and other portions of the sensor is crucial to reducing and eliminating the problems caused by buildup of debris, and numerous nozzles and systems exist for these purposes, such as those disclosed in international patent publication WO2017/070246A1 and US patent publication 2018/0029566A1, as well as U.S. Pat. Nos. 10,432,827; 10,350,647; 10,525,937; and 10,328,906, all of which are incorporated by reference.

In order to obtain sufficient coverage for cleaning sprays dispensed by these and other state-of-the-art nozzles/systems, current practices rely on adding nozzles to increase the overall cleaning coverage and/or to increase the range of spray or the volume of flow thereof, which can result in overlap between spray output of multiple nozzles. In any event, the added nozzles often result in increased costs.

Fluidic oscillator type washer nozzles are specific type of high efficiency spray performance (i.e., large coverage area and high exit velocity with low flow rate). More recent fluidic oscillator nozzles have improved performance with cold fluids (having viscosities of up to twenty-five centiPoise (25 cP)), which are particularly desirous in installations where outdoor temperatures approach or drop below the freezing point of cleaning liquids. Typical low flow, low pressure fluidic nozzle assemblies are highly compromised when forced to spray cold, viscous fluids.

Most known fluidic nozzles having comparatively small size/output spray fans are especially ineffective if low flow, low pressure (e.g., 15 psi or less) fluid is supplied. Specifically, those prior art nozzles cannot reliably generate an oscillating spray of droplets which provide satisfactory coverage and spray velocity to cover or clean a desired target surface. As such, a significant limitation of prior fluidic nozzles is that the nozzle assembly's package size needs to be large enough to handle the needed fluid flow; for example, the linear distance from the fluid inlet or feed to the exit orifice or front to back thickness customarily needs to be at least 6 mm for most fluidic circuits, especially if the spray application will include cold viscous fluids such as automotive windshield washing fluid or camera washing fluid, at very low temperatures.

For some installations (and particularly in many vehicles), package size is a concern due to very limited available space. Jet spray nozzles (i.e., a directed stream of fluid that does not oscillate or spread out into a larger fan) have been commonly used in such limited space applications because of their comparatively smaller footprint and ability to be manufactured in a single piece (in comparison to current fluidic solutions, many of which rely upon a two-piece construction in which an insert is fitted into a housing), but because of their very narrow spray pattern, jet spray nozzles typically must incorporate high fluid flow rates or must be operated for longer spray durations to effectively clean significant portions of glass or external lens surfaces. That is, jet spray nozzles do not have effective spray patterns for many automotive cleaning applications such as cleaning a camera lens, where the surface must be cleaned well, and without requiring a mechanical wiper or the like.

Also, many applications (and especially those in vehicles) prefer or require the outlet to align vertical to the inlet axis, e.g. for the outlet axis and inlet axis to be in the same planar surface; therefore, the spray fan and spray aim may be difficult to maintain as clean and stable due to the unbalanced streamlines between the inlet and the outlet. For example, current one-piece design shear nozzles do not have a clean spray fan and do not have stable spray aim, and the tooling of the designs may be difficult. Other current nozzles, such as that disclosed in WO 2017/070246, are two-piece designs, which can increase cost and complexity of the design, manufacture, and assembly (e.g., in a two-piece construction, the insert must fit and seal perfectly to the interior contours of the housing, while simultaneously insuring the outlet is properly aimed and aligned).

Given this, there is a need in the art for a fluid spray nozzle, or nozzles, that are able to produce a suitable spray pattern for cleaning a lens, such as LiDAR lens, that provides sufficient spray and cleaning coverage of the targeted area of the sensor surface. There is also a need for one piece design fluid spray nozzles that provide one or more (or all) of the following advantages: low cost, compact design, easy tooling methods of manufacture, good warm performance, good cold performance, sufficient spray at low flow and low pressure fluid conditions, balanced spray, clean spray, stable spray, etc.

### SUMMARY OF INVENTION

The disclosure relates to a shear type fluid spray nozzle having a small size (OD≤5 mm with an outlet width in the horizontal plane comprising between 10 to 25% of that diameter, e.g., 0.50 to 1.25 mm and, more preferably, about 0.70 to 1.00 mm for an OD 5 mm nozzle). The nozzle produces a desired shear spray pattern, and it is formed completely from one piece of material. The fluid spray pattern produced is appropriate for cleaning a lens, such as LiDAR lens, in that it delivers sufficient cleaning coverage of the targeted area. Further, this nozzle is lower cost and has more compact design in comparison to existing solutions, while its tooling simplifies methods of manufacture and it produces both good across a wide range of cold (i.e., ≤5° C. or within ≤10% of the cleaning fluid freezing temperature) and warm temperatures (i.e., ambient atmospheric temperatures in the summer, generally between 25 to 40° C.), sufficient spray at low flow and low pressure fluid conditions (i.e., so as to retain the desired spray pattern), balanced spray, clean spray, stable spray, etc.

Generally speaking, the invention contemplates a single-piece nozzle having a housing that defines an inner lumen. The inlet to the lumen is disposed at the bottom of the housing, while the outlet is oriented to project a shear spray pattern at an angle relative to the inlet axis of the lumen (i.e., the axis of the housing), with 90° angle (+/−≤20°) being preferred. The upper reaches of the lumen include transition area characterized by an arcuate slot and, in some aspects, one or two axial shoulders. The arcuate slot itself may be subdivided by a rib member, and the slot may include a radiused or straight cornered ceiling. The dimensions of the slot and the presence of the rib (which effectively provides for two arcuate slots proximate to the outlet) produce the desired spray patterns and aim. Significantly, this arrangement allows for manufacture of nozzles with sufficiently small size (less than 20.00 mm and, more preferably, less than 5.00 mm in major diameter, with outlet sizes between 5% to 25% of that diameter) to enable use—particularly vehicle cleaning systems—in systems where existing nozzles proved to be effective (in terms of low temperature or high viscosity performance, as well as in terms of producing consistent and desired spray patterns).

### BRIEF DESCRIPTION OF THE DRAWINGS

The present teachings may be better understood by reference to the following detailed description taken in connection with the following illustrations, wherein:

FIG. 1A is a perspective, cross sectional view and FIG. 1B is a side plan view, both showing a one-piece shear type nozzle of the prior art;

FIGS. 2A through 2C are photographs showing the spray pattern and output for the one-piece shear type nozzle of FIG. 1A;

FIG. 3A is a perspective view, FIG. 3B is a front plan view, and FIG. 3C is a side plan view, all showing exterior views of the housing according to one aspect of the invention;

FIG. 4A is a perspective view, FIG. 4B is a front plan view, FIG. 4C is a side plan view, FIG. 4D is a rear plan view, all showing exterior views of the housing according to a further aspect of the invention;

FIGS. 5A through 5E illustrate various features of a first aspect of the invention, with FIGS. 5A and 5B showing perspective cross sectional top views along axial planes 5A-5A and 5B-5B, as indicated in FIG. 5C which is a perspective cross sectional side view taken along a diameter of the housing that coincides with the outlet axis. FIG. 5D is a bottom plan view and FIG. 5E a perspective bottom view, with both illustrated to highlight certain features of the internal flow path.

FIGS. 6A through 6E illustrate various features of a second aspect of the invention, with FIGS. 6A and 6B showing perspective cross sectional top views along axial planes 6A-6A and 6B-6B, as indicated in FIG. 6C which is a perspective cross sectional side view taken along a diameter of the housing that coincides with the outlet axis. FIG. 6D is an bottom plan view and FIG. 6E a perspective bottom view, with both illustrated to highlight certain features of the internal flow path.

FIGS. 7A through 7D are photographs of the spray patterns achieved by nozzles according to the aspects of invention disclosed herein, with FIG. 7A showing a top view of typical spray fan, FIG. 7B showing a side view highlighting a spray aim of approximately 15°, and FIGS. 7C and 7D showing comparable views with fluid comprising 50% ethanol at 0° F. (10 CP) and at a pressure of 10-30 psi exhibiting a clean and stable spray fan angle with a spray aim angle maintained vertical to the inlet axis (e.g., perpendicular to the inlet axis).

FIGS. 8A and 8B are schematic cross-sectional views illustrating the general direction of flow of fluid through the nozzle of FIGS. 6A through 6E.

FIG. 9 is a schematic cross-sectional view of a third aspect of the invention possessing multiple shoulders to direct the flow path, with the arrows illustrating the general direction of flow.

FIG. 10 is a similar view to that shown in FIG. 5A, with flow arrows indicating how the spray fan emanates in a radial direction from the outlet.

### DETAILED DESCRIPTION OF THE DISCLOSURE

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

As used herein, an external sensor generally refers to a device exposed to an external environment of a vehicle to sense driving conditions, environmental conditions, or the general surroundings of the vehicle. Such external sensors may include visual light sensors or cameras (e.g., charge-coupled device, complementary metal-oxide semiconductor devices, etc.), radio detection and ranging (radar) sensors, light direction and ranging (LiDAR) sensors, and other types of sensors. Such sensors may be utilized to assist users in operation of a vehicle (e.g., blind spot monitoring, backup cameras, etc.). In another aspect, external sensors may be utilized for driverless or autonomous vehicles. Moreover, embodiments may refer to external sensors as exposed to an external environment where the external sensor may be disposed in a housing with a lens or other shielding device separating the external sensor from direct contact with the environment. As such, the lens may be considered a portion of the external sensor that is exposed to the external environment.

Described embodiments generally relate to a vehicle sensor cleaning system or fluid nozzles used in spraying and cleaning applications. A vehicle sensor cleaning system may automatically or autonomously (e.g., without user actuation) clean one or more external sensors based on an algorithm. The algorithm may determine cleaning parameters based on operating parameters associated with operation of the vehicle, an external environment, or stored preferences. For instance, the vehicle sensor cleaning system may utilize available data from the vehicle and other sources to clean sensors at operative times in an appropriate way. Sensors to be cleaned may be prioritized under which circumstances. Moreover, vehicle sensor cleaning systems may control cleaning processes to conserve cleaning fluid or power. As such, aspects disclosed related to the cleaning of the sensors herein may improve safety, accuracy of sensors, and environmental impacts associated with reduced use of cleaning solutions.

Both fully Autonomous Vehicles (Level 4 & 5) and vehicles that have driver assistance systems (ADAS—Level 1-3) that utilize sensors which may be cleaned by described embodiments for improved safety, reliability and function. As vehicles are exposed to debris and other environmental factors (e.g., temperature, etc.), the differing environmental conditions, vehicular situations, vehicle hardware and debris types are a few examples of real world variables or operating parameters that may be utilized by disclosed embodiments to determine an effective time to clean, method of cleaning, cleaning duration, type of fluid (types of liquid or air) or other parameters of a cleaning event. The described vehicle sensor cleaning systems may remove chances for human error and may result in more efficient cleaning.

Understanding many of the nozzles described herein (both in the background and in this description of invention) are formed within cylindrical housings, the terms height and axial will be used synonymously in certain contexts, while the terms length (or width) will be understood as extending radially away from this axis. In most instances, the radial plane will extend orthogonally away from the central axis. In this manner, reference to horizontal may be synonymous with radial and vertical may be synonymous with axial. Finally, top and bottom should be understood in the context of the drawings, in which the inlet (when depicted) is shown at the bottom of the image, with the top being disposed opposite that inlet.

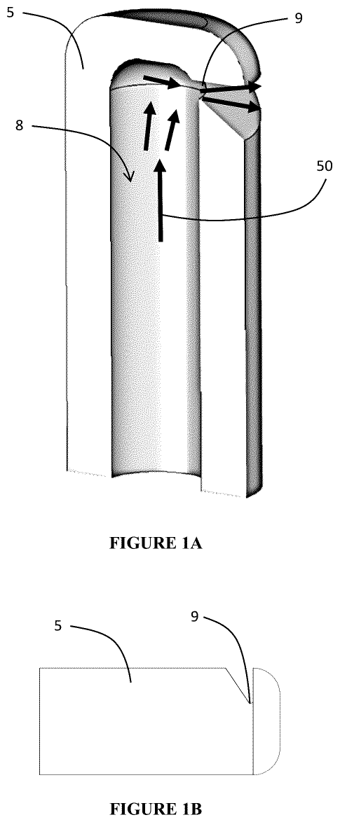

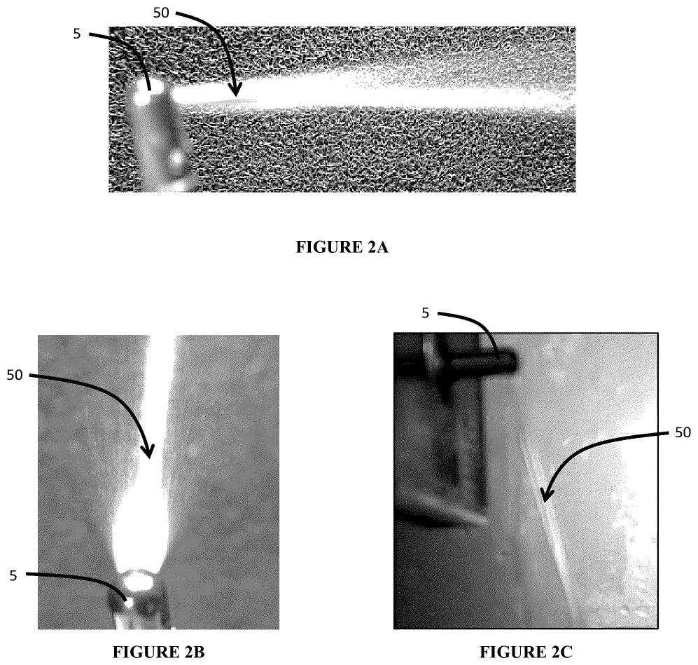

FIGS. 1A-B show a one-piece shear type nozzle 5 of the prior art, with FIGS. 2A-C illustrating the fluid spray 50 produced by such nozzles. The fluid spray 50 may be distributed by the nozzle 5 of the prior art and may be applied to a lens or sensor surface on a vehicle. Here, the design of the nozzle 5 results in a messy spray because of unbalanced feed and flash at shut off surfaces. Also, the spray fan and aim of the fluid spray 50 from nozzle 5 can undesirably change at different pressures and viscosities of the fluid. The nozzle 5 further may not be able to achieve a 0 degree spray aim (e.g. a flat spray fan vertical to an inlet axis). Also, the shape and tooling of the outlet surface 9 shown in FIG. 1B may be difficult to achieve in manufacture and can cause flash at the shut off lines.

In terms of structure, prior art nozzles tend to be formed as a cup-shaped cylinder, in which the hollow inner lumen/fluid channel 8 conforms to the cylindrical shape presenting on the outside (e.g., a circular cylinder, as seen in FIG. 1A). This results in unbalanced feed streamlines, e.g. due to the outlet surface 9 as it relates to the fluid channel 8 therein, which makes the fluid spray 50 cone-shaped (e.g. not 0 degree spray aim) and increases the spray aim, as shown in FIGS. 2A-C. Also, the large exit opening at the outlet surface 9 and the unbalanced feed as described may contribute to the undesirable and varying spray fan and spray aim of the fluid spray 50 at different pressures and viscosities. FIG. 2C, for example, shows a fluid spray 50 of a 50% methanol fluid at 0° F. and at 13-30 psi, which produces a three-dimensional cone-shape for the fluid spray pattern that may be undesirable when trying to clean a fixed surface (as is the case in most vehicle applications).

Based on the inconsistent and messy fluid spray 50 patterns resulting from the design of nozzle 5, portions of the lens or sensor surface remain outside the range of the fluid spray 50 of fluid nozzle 5. In particular, the fluid spray 50 shown in FIGS. 2A-C (resulting of the geometry of nozzle 5 shown in FIGS. 1A-B) generates variable and asymmetrical cleaning patterns for the nozzle 5 on the surface of the lens or sensor surface where overspray may leave large sections at bottom or at the outer edges of the target non-impacted, dry, or otherwise not fully cleaned (particularly when the fluid spray 50 is cone-shaped).

These missed areas remaining outside of the fluid spray 50 of nozzle 5 are likely to remain uncleaned and can be a frequent issue with traditional shear, fanning, or distributed sprays. Such spray patterns often result in reduced cleaning efficacy of the lens or sensor surface which lead, in turn, to undesirable and impeded/impaired functionality of the sensors and system. Notably, this issue may exist with a single fluid nozzle or cleaning device as well as a system that incorporates two or more fluid nozzles for spraying a common surface. This issue may also exist at various pressures and temperatures of the fluid and may become worse or more exaggerated at certain pressures and temperatures. As a result, to the extent these sensors are crucial to the safe operation of a vehicle, improper cleaning can lead to malfunction and risky/dangerous operation of the vehicle.

In order to overcome these and other deficiencies, a shear type fluid spray nozzle having a small size (i.e., ≤20.00 mm and, more preferably, ≤5.00 mm) is contemplated. This nozzles produces a shear spray by relying on an inlet having an axis tracing the fluid flow therethrough that is generally transverse, and may be orthogonal, relative to an axis bisecting the outlet. In some aspects, the internal geometry of the fluid spray nozzle separates flow of fluid within the cavity to maintain the spray aim and spray fan shape at a desirable condition.

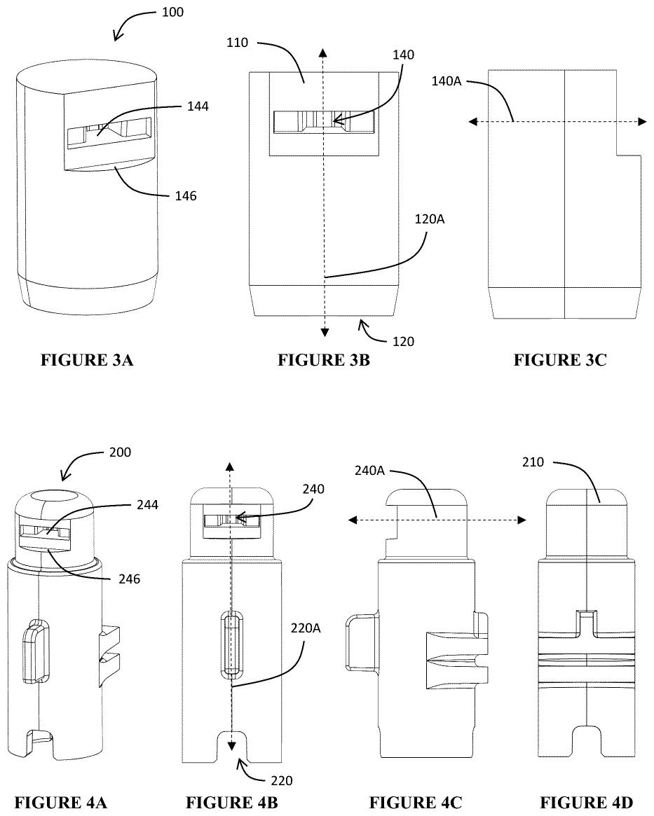

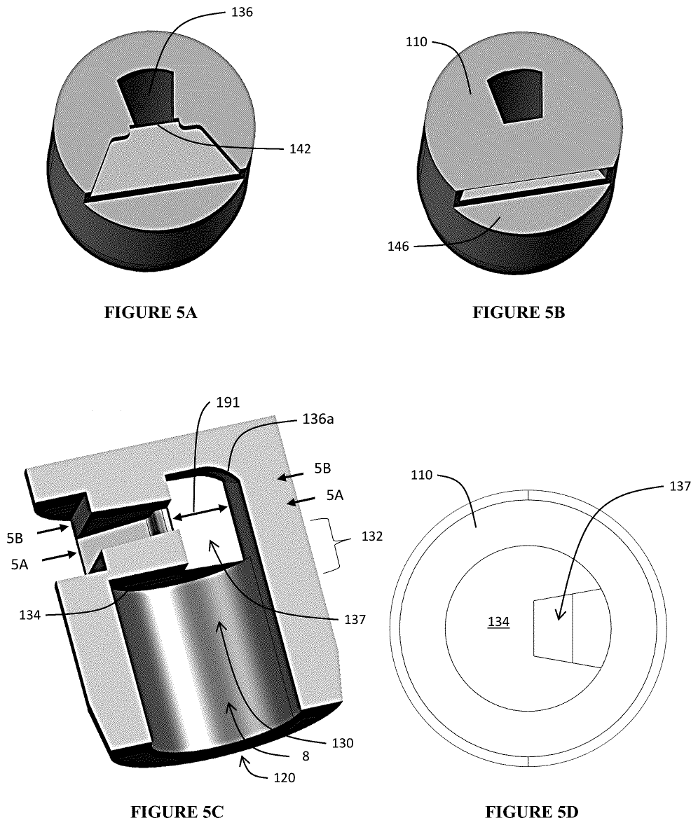

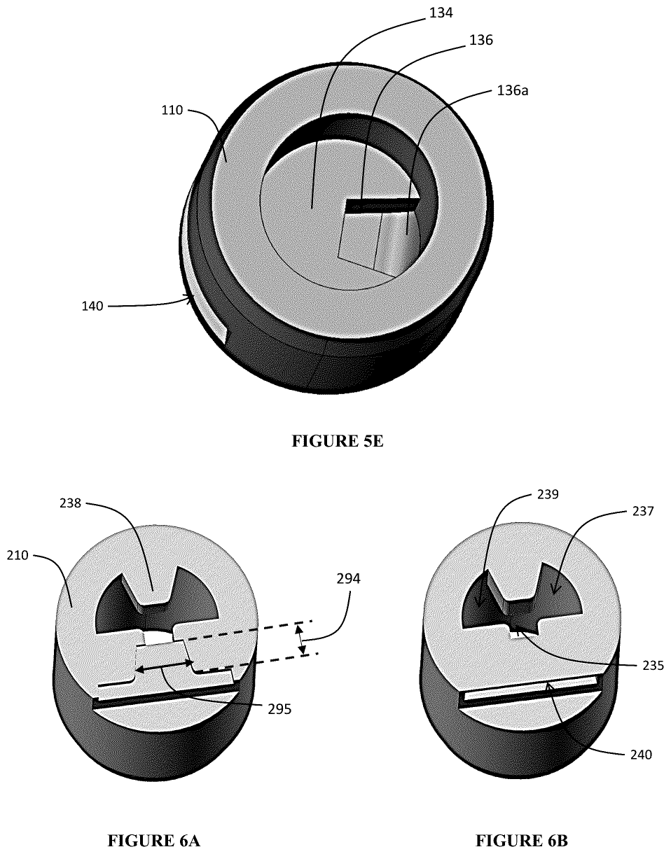

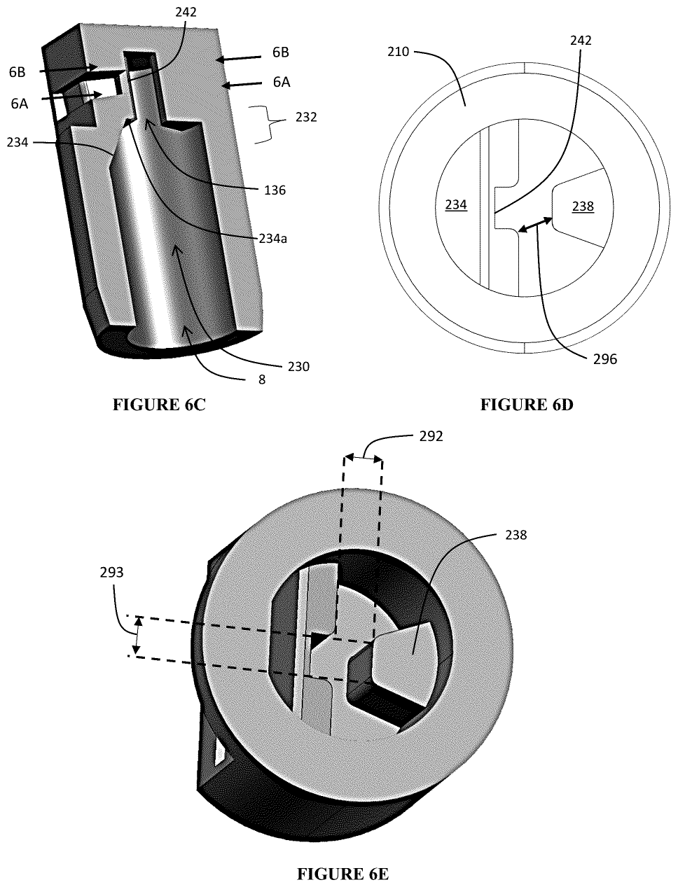

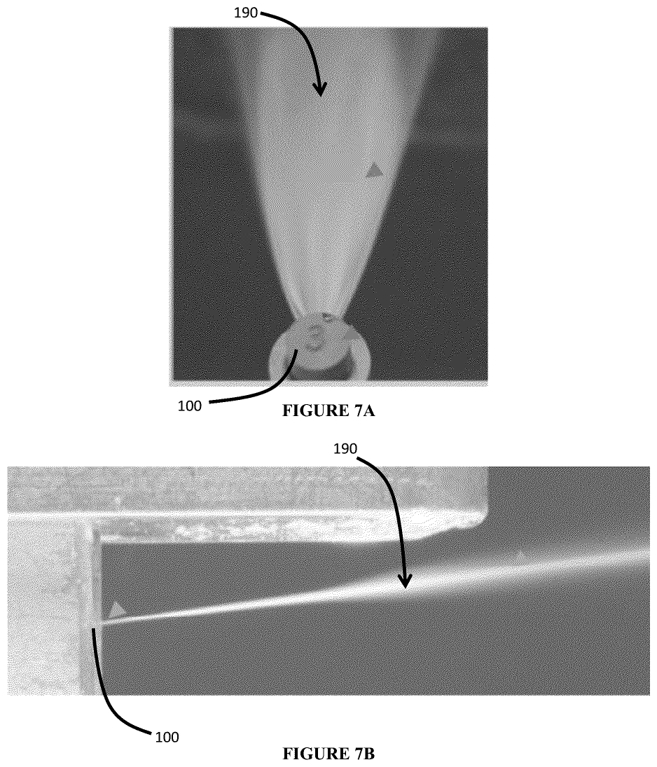

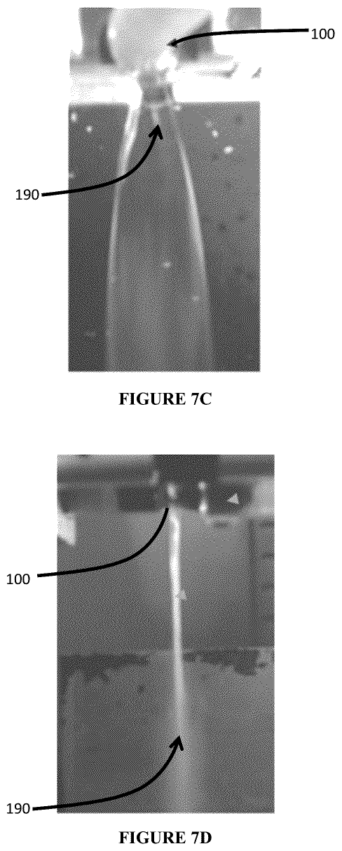

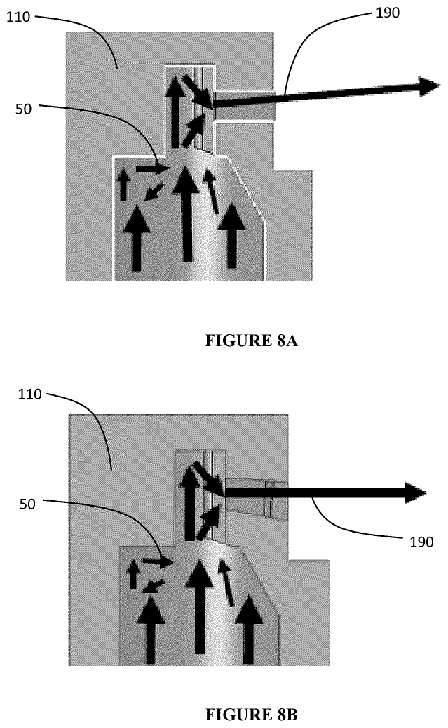

FIG. 3A to 3B shows a first embodiment of the housing for a fluid spray nozzle 100, whereas FIG. 4A to 4D shows an alternative arrangement. Both nozzles are capable of producing the spray patterns pictured in FIG. 7A to 7D and, throughout the drawings, it will be understood that arrows positioned within the inner lumens defined by these nozzles/housings are indicative of the flow pattern for cleaning fluid passing through that nozzle (e.g., FIG. 8A to 9). In general, FIGS. 5A to 6E are drawn to scale, so that (as examples) the width of the outlet in the stepped region (i.e., outside of the inner lumen) is larger than at the edge/beginning of the outlet and/or the width of the outlet may be substantially similar to the width of the protrusion. Other similar comparative spatial relationships can be inferred.

While prior art nozzles formed as a single, integral member exhibited the shortcomings noted above, the inventors discovered the provision of additional features within the lumen produce beneficial results in comparison to the prior art. In particular, while the inlet area can generally conform to the cylindrical shape presented by the housing (and, more ideally, a curved or circular cylinder), the provision of features that redirect the flow within the transition area where the lumen redirects fluid out of the outlet seems to impart the unique and desired characteristics to the spray pattern—especially in cold weather and/or high viscosity conditions (with it being understood in the art that the range of ambient temperatures in which most vehicles operate is broad enough to induce viscosity changes in most alcohol- and/or aqueous-based cleaning solutions, i.e., between ˜−20° to ˜40° C.).

With reference to a first aspect of the interior features highlighted in FIG. 5A to 5E, the fluid spray nozzle 100 may comprise a body 110 that defines an inlet 120, a cavity 130, and an outlet 140. In an embodiment, the cavity 130 may be aligned along a central inlet axis 120A and the outlet 140 may be aligned along an outlet axis 140A. An outlet axis 140A intersects the inlet axis 120A within cavity 130. In an embodiment, the outlet axis 140A may be generally biased to the inlet axis 120A or cavity 130 and, more specifically, the outlet axis 140A may be generally perpendicular to the inlet axis 120A or cavity 130. In a further embodiment, the outlet axis 140A may be approximately 60° to 120° from the inlet axis 120A or cavity 130 and, more specifically, between 80° to 100°. It is noted that other ranges not specified are also contemplated and disclosed.

Fluid may flow from the inlet 120, through the cavity 130, and out of the fluid spray nozzle 100 through the outlet 140 to provide a spray pattern 190. Generally speaking, the surface area at the inlet 120 is larger than that at the outlet 140 and, in an embodiment, it is anywhere from two to five times larger. The comparative size of the outlet 140 can also be expressed as a function of the major diameter of the body 110, with the length of the outlet being 10 to 20% of the diameter, and/or as a function of the height of the body 110, with the height of the outlet being 10% or less of the total height of the body 110 or the fluid channel 8.

The cavity 130 may include a transition portion 132 between the inlet 120 and the outlet 140 of the fluid spray nozzle 100. The transition portion 132 may include a shoulder member 134 below the outlet and an arcuate slot 136 opposite and above the shoulder member 134. The slot 136 is spaced laterally from/behind the outlet 140, with the transition portion 132 disposed adjacent to the outlet 140. In an embodiment, the transition portion 132 narrows in diameter so as to have a smaller size than the inlet 120.

As additional aspects, one or both of the shoulder member 134 and the ceiling of the slot 136 (i.e., the topmost boundary of inner lumen/fluid channel) may present as flat, planar surfaces, either angled or generally perpendicular the cavity and inlet axis 120A. In an embodiment, one or both the shoulder member 134 and the slot 136 may be generally horizontal or aligned along a plane that is parallel to the outlet axis 140A. Or, the shoulder member 134 and the ceiling of the slot 136 may be generally perpendicular the cavity and inlet axis 120A, and generally parallel the outlet axis 140A.

Relative to the axial height or elevation of the inner lumen, the shoulder member 134 may begin or be entirely positioned at a different elevation in comparison to the top and bottom of the slot 136. In an embodiment, one or both the shoulder member 134 and the slot 136 may be a top surface of the cavity 130 or may otherwise stop or redirect fluid flow at that position. In an embodiment, the cavity 130 may narrow at the shoulder member 134 and/or at the bottom of the slot 136. In an embodiment, the cavity 130 may progressively narrow at both the shoulder member 134 and the slot 136. Particularly as shown in FIGS. 8A to 9, the shoulder 134 may be interrupted by the slot 136, with one section (e.g., under the outlet) partially or completely angled, while the section on an opposing side of the slot 136 (i.e., radially away from the outlet) can be horizontal/flat. A series of angled sections 134, 134a and flat portions may be formed on one or both sides.

Notably, the ceiling of the slot 136 may include a curved or radiused section 136a on the opposing side relative to the outlet 140. Also, in radial cross section (as seen in FIG. 5A or 5B), the slot possesses a triangular shape, preferably with a curved or arcuate wall disposed opposite where fluid can access the outlet 140. It should also be noted that a vertical wall section may be disposed immediately above the outlet within the slot 136.

Throughout the drawings, the redirection of the fluid flow 190 at the shoulder member 134 and at the slot 136 can be seen by the arrows 50 changing direction the fluid contacts each the shoulder member 134 and the slot 136. In an example, the spray aim angle (e.g. the spray of fluid that exits the outlet 140) may depend on the vector of main streamline exit the cavity 130 or throat (e.g. through the outlet 140). The stronger the upright streamline flow (e.g. from the inlet 120 and through the cavity 130 in a generally vertical direction), the higher spray aim. The feed hole (e.g. at or near the outlet 140) is intentionally biased to the big inlet feed hole (e.g. the inlet 120) to have a vortex region (e.g. at the shoulder member 134 and/or slot 136, and the respective chambers thereof 135, 137) to break the mainstream flow (e.g. from the inlet 120 into the cavity 130) into various flows (e.g. at the chamber 135 of the shoulder member 134 and/or at the chamber 137 defined by the slot 136) so that the spray fan (e.g. the spray of fluid that exits the outlet 140) can be flat and uniform (e.g. rather than undesirably cone-shaped).

In an example, the shoulder member 134 may interact with fluid entering the cavity 130 from the inlet 120 so as to break or redirect the fluid flow by serving as a stop point in the cavity 130. The shoulder member 134 may create a chamber area 135 where fluid flow occurs in more than one direction, in opposite directions (e.g. away from and towards the inlet 120 for example), in vertical and/or horizontal directions, in circular or vortex-like directions, or similar. The shoulder member 134 may be closer to the inlet 120 than the slot 136 and may be located on the outlet 140 side of the cavity 130. It is noted that opposite configurations are also contemplated and disclosed where the shoulder member 134 may be further from the inlet 120 than the slot 136 and/or may be located opposite the outlet 140 side of the cavity 130. Without wishing to be bound by any theory, the inventors believe the positioning of the shoulder 134, the size of the chamber 137, and/or the shape and elevation of the slot 134 and shoulder 134 may help to promote vortex formation which should stabilize and shape the spray patterns of nozzle 100.

The slot 136 helps to define the upper boundary of the cavity 130 between the inlet 120 and the offset outlet 140. Fluid entering the cavity 130 from the inlet 120 and/or from the shoulder member 134 is redirected so that flow in the transition area 132 and/or the chamber 137 may occur in more than one direction, in opposite directions (e.g. away from and towards the inlet 120 for example), in vertical and/or horizontal directions, in circular or vortex-like directions, or similar. Further, the radial “depth” of the slot 136 (i.e., the distance 191 from the outlet 140 to the back wall) may be larger than that from the inlet 120 than the shoulder member 134 and/or from may be opposite the outlet 140 side of the cavity 130. It is noted that opposite configurations are also contemplated and disclosed where the slot 136 may be closer to the inlet 120 than the shoulder member 134 and/or may be located on the outlet 140 side of the cavity 130. The slot 136 and shoulder member 134 may also be positioned at relatively the same axial heights within the cavity 130 or on the same side of the cavity 130 either opposite the outlet 140 or on the outlet 140 side.

The shoulder member 134 directs the fluid flow back into the shoulder chamber 135, back into the cavity 130 towards the inlet 120, and/or back into the cavity 130 towards the slot 136 and chamber 137 (e.g. in a vortex like fashion or by further contact with the cavity 130 walls and with the mainstream flow of fluid from the inlet 120). In an embodiment, the slot 136 (by virtue of its wedge-like shape and/or its axial profile) may direct fluid flow back into the rib chamber 137, back into the cavity 130 towards the inlet 120, and/or into and through the outlet 140. In an embodiment, the main fluid flows (e.g. from the inlet 120 within the cavity 130 in a vertical direction) may hit the top surface the lumen, which then generates various streamlines (high turbulent flows) inside this small region (e.g. the chamber 137). In an embodiment, the main fluid flows (e.g. from the inlet 120 within the cavity 130 in a vertical direction) may hit the top surface (e.g. the shoulder member 134), which then generates various streamlines (high turbulent flows) inside this small region (e.g. the shoulder chamber 135).

The chamber 137 feeds into the outlet 140. In an embodiment, the outlet 140 may be reduced at the point 142 that the fluid flow exits the body 110 of the fluid spray nozzle 100 from the chamber 137 and may then open wider through the outlet 140. The outlet 140 may be recessed from an outer surface of the body 120 and include a stepped exterior geometry (i.e., outside of the inner lumen), having a first step 144 and a second step 146, for example, where the first step 144 opens wider than the outlet point 142 and the second step 146 opens wider than the first step 144. While these features are nominally outside of the lumen, they may still help to influence and shape the spray patterns contemplated herein, especially with respect to the top and bottom surfaces in the first stepped region 144.

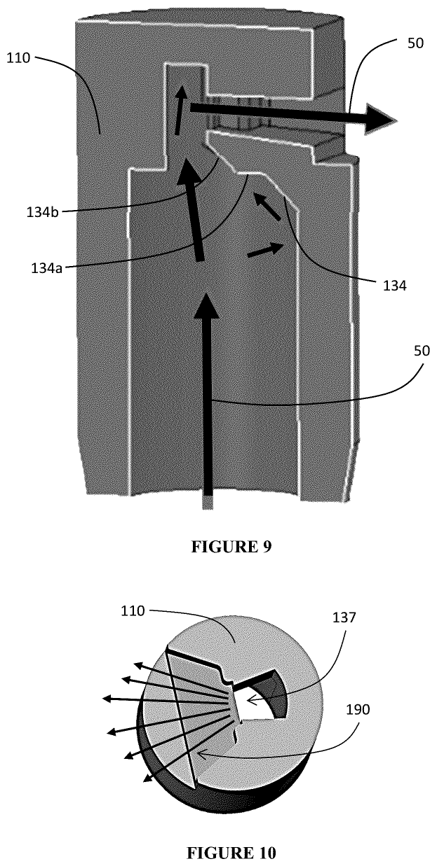

The ability to alter fluid flows at or within the slot 136, the shoulder member 134, and their respective chambers 137, 135, impacts the spray aim, angle, and fan shape as the fluid then proceeds to exit the fluid spray nozzle 100 through the outlet 140/142. In an embodiment, when the compressed various streamlines from the cavity 130 or rib chamber 137 exit the spray fluid nozzle 100 through the outlet point or throat 142, a shear spray fan is formed by releasing flows on both sides, as shown in in FIG. 10. The distance shown as 191, shown in FIG. 5C, e.g., radial length the slot 136, may be increased or decreased based on the desired spray aim. In an embodiment, decreasing distance 191 can decrease or improve the spray aim. In an embodiment, the stepped geometry 144, 146 of the outlet 140 having an exit length and exit width could be modified to change the characteristics of the spray pattern 190. The stepped geometry 144, 146 may act to separate a main flow of fluid within the cavity 130 and chambers 135, 137 to maintain the spray aim and spray fan shape at a desirable condition.

FIG. 10 shows an example of the spray fan as the fluid flow 190 exits the outlet point 142, entering the stepped geometry 144, 146 of the outlet 140 and exiting the body 110 of the fluid spray nozzle 100. The images in FIGS. 7A to 7D similarly show examples of the spray fan from various disclosed aspects of the fluid spray nozzle 100. FIG. 7B shows the spray aim of the fluid flow 190 using the fluid spray nozzle 100, and shows a spray aim of approximately 15°. As disclosed and described, the spray fan and the spray aim of the fluid flow 190 of the fluid spray nozzle 100 may be adjusted as desired by changing one or more (or all) of the geometries of the slot 136, chamber 137, shoulder 134, shoulder chamber 135, outlet point 142, and/or stepped geometry 144, 146 of the outlet 140, or any other aspects as disclosed and described herein, as well as through the use of one or more ribs 236 (thereby effectively providing a plurality of slots 136) or additional shoulders 134a as described below.

The spray pattern 190 produced by the fluid spray nozzle 100, in contrast to the spray patterns 50 shown in FIGS. 1-2 for nozzle 5, may permit full, uniform coverage on the lens or sensor surface despite the location or packaging of the nozzle. This can produce the most impacted area of the lens or sensor surface, avoiding shortcomings of prior art spray patterns while using the same volume of fluid. The spray fan and spray aim of fluid spray nozzle 100 may also have improved spray fan and spray aim to optimize one of more (or all) of cleaning, sensor coverage, fluid waste, and the like.

FIGS. 6A to 6E show a second embodiment of a fluid spray nozzle 200, with it being understood certain reference numerals may be carried over from the first embodiment (or analogous elements being introduced as a 200 series, rather than 100 series). Significantly, fluid spray nozzle 200 provides a rib or protrusion 238 within the slot 136 so as to produce two chambers 237, 239 that serves to redirect the mainstream fluid flow 190 from the inlet 220 in the cavity 230. This additional structure enables further adjustment the spray aim and spray fan as desired.

As above, the shoulder member 234 in the fluid spray nozzle 200 may be angled, flat, divided, etc. Also, the fluid spray nozzle 200 may comprise a body 210 that defines an inlet 220, a cavity 230, and an outlet 240. The cavity 230 may be aligned along an inlet axis 220A and the outlet 240 may be aligned along an outlet axis 240A. All of the variables regarding these elements (as indicated above) may be set and comparatively adjusted.

Similarly, the cavity 230 may include a transition portion 232 between the inlet 220 and the outlet 240 of the fluid spray nozzle 200, including a shoulder member 234 below the outlet 240. However, a rib member 238 is disposed opposite the shoulder member 234. As such, rib 238 forms an opposite shoulder member 234 beneath it. The rib member 238 divides the slot 136, preferably into two identically shaped and spaced apart chambers 237, 239. The rib 238 is also spaced from the outlet 240 at distance 292, as the transition portion 232 may be adjacent to the outlet 240.

In an embodiment, the transition portion 232 has a smaller size than the inlet 220. In an embodiment, one, more, or all the shoulder member 234, the rib member 238, and the ceilings in chambers 237, 239 (i.e., the topmost portion of the inner lumen/fluid chamber) may be horizontal/radially aligned planar surfaces. One, more, or all the shoulder member 234, the rib member 236, and protrusion 238 may be generally perpendicular to the inlet axis 120A and/or generally parallel the outlet axis 140A. As shown in FIG. 6C, the shoulder member 234 may be angled (e.g., neither perpendicular nor parallel to the inlet axis 220A or outlet axis 240A), with the shoulder member 234 and the rib/protrusion 238 positioned at different axial heights along the cavity 230 and, regardless of comparative heights, these structures may otherwise stop or redirect fluid flow with the goal of producing specific spray patterns based upon the same principles discussed above. In an embodiment, the cavity 230 may get smaller at one, more, or all the shoulder member 234 and protrusion 238. The protrusion has a wedge or triangular shape in the radial plane, preferably so as to create mirror image chambers 237, 239 on either side of it. Thus, the rib 238 should extend all the way to the ceiling in both chambers 237, 239. As above, the sidewall of the chambers 237, 239 that is opposite the outlet 240 may and preferably does have a curved presentation, while the main space of those chambers is triangular. Because the rib 238 is offset by distance 296 from the walls defining the outlet 240, the slot 136 has a C-shape as seen in FIG. 6E. Also, in this arrangement, portions of the fluid flow can advance vertically upward parallel to the inlet axis 240A until contacting the ceiling of the chambers 237, 239.

The redirection of the fluid flow at the shoulder member 234 and protrusion 238 can be seen by the arrows changing direction the fluid contacts each the shoulder member 234 and protrusion 238. In an example, the spray aim angle (e.g. the spray of fluid that exits the outlet 240) may depend on the vector of main streamline exit the cavity 230 or throat (e.g. through the outlet 240). The stronger the upright streamline flow (e.g. from the inlet 220 and through the cavity 230 in a generally vertical direction), the higher spray aim. The feed hole (e.g. at or near the outlet 240) is intentionally biased to the big inlet feed hole (e.g. the inlet 220) to have a vortex region (e.g. at the shoulder member 234 and/or protrusion 238 and the chambers 235, 237, 239) to break the mainstream flow (e.g. from the inlet 220 into the cavity 230) into various flows (e.g. at the chamber 235 of the shoulder member 234, at the chambers 237, 239 of the rib member 238) so that the spray fan (e.g. the spray of fluid that exits the outlet 240) can be flat and uniform (e.g. rather than undesirably cone-shaped).

In an example, the shoulder member 234 may interact with fluid entering the cavity 230 from the inlet 220 and/or from the protrusion 238, and break or redirect the fluid flow by serving as a stop point in the cavity 230. The shoulder member 234 defines part of chamber area 235 (which bridges and connects chambers 237, 239, thereby forming a C-shape) where fluid flow occurs in more than one direction, in opposite directions (e.g. away from and towards the inlet 220 for example), in vertical and/or horizontal directions, in circular or vortex-like directions, or similar. The shoulder member 234 may be closer to the inlet 220 than the rib member 238, or it may be located on the outlet 240 side of the cavity 230, or both. It is noted that opposite configurations are also contemplated and disclosed where the shoulder member 234 may be further from the inlet 220, etc.

The protrusion 238 interacts with fluid entering the cavity 230 from the inlet 220, from the shoulder member 234, and/or from the underside of the rib 238 (i.e., the portion of shoulder 234 opposite the outlet 240), so as to break or redirect the fluid flow by serving as a stop point in the cavity 230. The protrusion 238 defines a chamber areas 237, 239 where fluid flow occurs in more than one direction, in opposite directions (e.g. away from and towards the inlet 220 for example), in vertical and/or horizontal directions, in circular or vortex-like directions, or similar. The protrusion 238 may be further from the inlet 220 than the shoulder member 234, or it may be opposite the outlet 240 side of the cavity 230. It is noted that opposite configurations are also contemplated and disclosed as well. The protrusion 238 and shoulder member 234 may also be positioned at relatively the same axial heights within the cavity 230 or on the same side of the cavity 230 either opposite the outlet 240 or on the outlet 240 side. It is noted that either or both the protrusion 238 and shoulder member 234 may be generally horizontal or angled (e.g., parallel with the outlet axis 240A and perpendicular to the inlet axis 220A), generally angled (e.g., not parallel with or perpendicular to either the outlet axis 240A or inlet axis 220A), or a combination of the two.

In an example, the rib member 238 may be viewed as the top surface of the cavity between the inlet 220 and the offset outlet 240. In an example, the rib member 238 may interact with fluid entering the cavity 230 from the inlet 220, from the shoulder member 234, and/or from the protrusion 238, and may break or redirect the fluid flow by serving as a stop point in the cavity 230. As previously noted, the rib member 238 and the shoulder 24 separately and in combination function to effectively create fluid flow in more than one direction, in opposite directions (e.g. away from and towards the inlet 220 for example), in vertical and/or horizontal directions, in circular or vortex-like directions, or similar.

In an embodiment, the chambers 235, 237, 239 feed into the outlet 240, although the outlet is directly fed only by chamber 235 (conversely, all three chambers can be considered as part of the slot 136, only with a dividing rib 238 positioned therein). In an embodiment, the outlet 240 may be reduced at the point 242 that the fluid flow exits the body 210 of the fluid spray nozzle 200 from the rib chamber 237 and may then open wider through the outlet 240. The outlet 240 may be recessed from an outer surface of the body 220 and include a stepped geometry, having a first step 244 and a second step 246, for example, where the first step 244 opens wider than the outlet point 242 and the second step 246 opens wider than the first step 244.

In an embodiment, the changing fluid flows noted above serve to change the spray aim and spray fan as the fluid then proceeds to exit the fluid spray nozzle 100 through the outlet 240/242. In an embodiment, when the compressed various streamlines from the cavity 230 or rib chamber 237 exit the spray fluid nozzle 200 through the outlet point or throat 242, a shear spray fan may be formed by releasing flows on both sides, similar to the pattern in FIG. 10. In an embodiment, the size or length of the protrusion 238, may be increased or decreased based on the desired spray aim. In an embodiment, increasing the size or length of the protrusion 238 can decrease or improve the spray aim, i.e., by changing the rib width 293, the radial offset 292, etc. In an embodiment, the stepped geometry 244, 246 of the outlet 240 having an exit length and exit width could be modified to change the characteristics of the spray pattern. The stepped geometry 244, 246 may act to separate a main flow of fluid within the cavity 230 and protrusion/rib/shoulder chambers 238/236/234 from the inlet 230 to maintain the spray aim and spray fan shape at a desirable condition. While these features 244, 246 are nominally outside of the lumen, they may still help to influence and shape the spray patterns contemplated herein, especially with respect to the top and bottom surfaces in the first stepped region 244.

In an embodiment, adding protrusion 238 to separate the main flow (e.g. from the inlet 220 into the cavity 230) and increase turbulence (e.g. by creating additional turbulence within the protrusion chamber 239) level may help increase spray fan and maintain the spray aim at around 4° up. The geometry may also allow for better tooling condition (e.g., thicker steel blade tip). The spray pattern and aim may be defined by inlet/outlet width 292 and protrusion width 293. The higher flow direct from center (bigger inlet/outlet width or smaller protrusion width), the higher spray aim and heavier center spray. The spray pattern of fluid spray nozzle 200 may be center heavy with light spray edges. The natural spray without exit edges (exit length=0) may be more than 60°. In an embodiment, the function of exit edges is to converge scattering side sprays to clean spray edges. The spray fan could be decreased by increasing exit length 294 or decreasing exit width 295 (see FIG. 6A and note the same dynamics can be applied to outlet 140 and nozzle 100).

In an embodiment, because there may be a 90° turn between inlet axis 220A and outlet axis 240A, the fluid flows exit through to the throat may tend to spray up (high aim). Reducing the inlet/outlet width 292 may reduce high aim. In an embodiment, reducing the inlet/outlet width 292 may be limited for some tooling purposes. In an embodiment, the smallest gap or minimum passage size 296≥0.6 mm. The throat wall thickness 297 may affect the spray fan. In an embodiment, reducing the throat wall thickness 297 could help spray fan expand bigger. In an embodiment, the throat wall thickness 297 may be ≥0.4 mm for tooling purpose. A direct way to reduce spray aim may be to add a down exit slot angle or to change the angle of the first step 244 of the outlet 240. For example, the exit slot angle=0° of the first step 244 may correspond to spray aim=4°, while changing exit slot angle of the first step 244 to −4° could reduce the spray aim angle to 0°. A down exit slot angle may increase the difficulty of tooling. For tooling difficulty, it may be desirable that the fluid spray nozzle be formed from plastic, e.g., injection molded or that the geometries of the fluid spray nozzle 200 are made to optimize ease of manufacture or tooling for e.g., metal fluid spray nozzles. As before, these concepts and teachings may also be applied to nozzle 100.

FIGS. 7A to 7D show examples of the spray pattern and fluid flow of the fluid spray nozzles 100, 200. By way of example rather than limitation, the following criteria produce an acceptable spray pattern: fan=35°, aim=0°, FR (flowrate)=300 ml/min at 25 psi, min. passage size=0.6 mm, nozzle outside diameter=5 mm. In this manner, the nozzle worked well with fluids ranging in viscosity from 1-25 CP (e.g., water at 25 psi is shown in FIGS. 7A and 7B, whereas FIGS. 7C and 7D show 50% methanol at 0° F. (25 CP) and at a pressure of 10-30 psi). All of these photographs illustrate a spray fan angle that is clean and stable and a spray aim angle maintained vertical to the inlet axis (e.g., perpendicular to the inlet axis).

As disclosed and described, the spray fan and the spray aim of the fluid flow of the fluid spray nozzle 200 may be adjusted as desired by changing one or more (or all) of the geometries of the protrusion 238, chambers 235, 237, 239, shoulder 234, outlet point 242, and/or stepped geometry 244, 246 of the outlet 240, or any other aspects as disclosed and described herein, such as aspects 191, 292-297, 244.

The spray patterns in FIGS. 7A to 7D are in contrast to those shown in FIGS. 1-2 for prior art nozzle 5. In particular, the spray patterns from the novel nozzles 100, 200 permit full, uniform coverage on the lens or sensor surface despite the location or packaging of the nozzle, so as to maximize impacted area of the lens or sensor surface and to avoid shortcomings of the prior art while using the same volume of fluid. The spray fan and spray aim of fluid spray nozzle 200 may also have improved spray fan and spray aim to optimize one of more (or all) of cleaning, sensor coverage, fluid waste, and the like.

In an embodiment, the exit throats (e.g. outlet point 142, stepped geometry 144, 146 within the body 110, or outlet 140) may be shaped in the same plane or may be generally aligned. In an embodiment, the exit throats (e.g. outlet point 142, stepped geometry 144, 146 within the body 110, or outlet 140) may not be offset. In an embodiment, the exit throats (e.g. outlet point 142 or outlet 140) may be have more than one inlet region, such as those shown in the fluid flow 190 of FIG. 7B. This is true for all fluid spray nozzles disclosed herein, including nozzles 200, 300, and combinations of 100, 200, 300, etc.

In an embodiment, the fluid nozzles include structure for distributing fluid through channels formed by a small one-piece shear nozzle assembly. The fluid nozzles introduce fluid from a bottom of nozzle along a nozzle axis, then distribute it at an angle about 90 degrees from the inlet. The fluid nozzles include a nozzle body that may be small. In an embodiment, disclosed is a single piece nozzle body that defines a cavity with an inlet and outlet with an outer diameter less than about 5 mm; a rib member and/or protrusion placed adjacent an exit of the outlet, a shoulder member placed adjacent the exit, and an outlet geometry with a stepped orientation aligned with the exit and rib (and/or protrusion) member. In an embodiment, the fluid spray nozzle may include one or more shelves between the inlet and outlet, and within the cavity, to direct fluid flow. For example, the fluid spray nozzle may include one shelf or deflecting surface (e.g. shoulder member 134) between the inlet and outlet, and within the cavity, to direct fluid flow; two such surfaces (e.g. any combination of shoulder member 234 and 234a) between the inlet and outlet, and within the cavity, to direct fluid flow; or three surfaces (e.g. all of shoulder member 134, 134a, and slot 134b) between the inlet and outlet, and within the cavity, to direct fluid flow.

While any combination of aspects of the invention can be discerned according to the foregoing disclosure, specific embodiments contemplate a one-piece, shear spray nozzle for a sensor cleaning system. The nozzle is formed from a hollow cylindrical housing including an inlet that feeds a cavity and an outlet projecting a spray pattern an angle relative to an inlet flow axis. The cavity inside the housing includes a shoulder positioned next to a arcuate slot, with the outlet formed in a sidewall defining a portion of the arcuate slot, and so that the outlet is positioned axially above the shoulder. Notably, the small size of the nozzle is a consideration, so that the housing has a major diameter of less than 20.00 and, more preferably, less than 5.00 mm and the outlet has a width that is between 5% and 25% of the major diameter. Additional embodiments include any combination or permutation of the following features:
wherein the angle is perpendicular to the inlet flow axis;
wherein the shoulder includes a first flat planar surface that is formed at an angle relative to the inlet flow axis;
wherein the shoulder includes a second flat planar surface that is perpendicular to the inlet flow axis;
wherein the slot is disposed between and above the first and second planar surfaces;
wherein the outlet includes a stepped region formed outside of the cavity;
wherein top and bottom planar surfaces are: i) connected to the outlet outside of the cavity, ii) define a portion of the stepped region, and iii) are positioned at non-perpendicular angles relative to the inlet flow axis;
wherein a width of the stepped region is greater than a width of the outlet;
wherein the arcuate slot includes a curved transition to a top wall is disposed at an opposite end of the arcuate slot in comparison to the outlet;
wherein the arcuate slot has a generally triangular cross-sectional profile with the outlet disposed at a corner of the triangular profile and an opposing wall configured at a distance from the corner that produces a flat shear spray pattern in fluid expelled through the outlet;
wherein the arcuate slot includes a protrusion that divides the arcuate slot into two separate chambers;
wherein the two separate chambers have identical dimensions;
wherein the width of the protrusion is substantially similar to a width of the outlet;
wherein the protrusion is radially spaced apart from the outlet at a distance that produces a flat shear spray pattern in fluid expelled through the outlet;
wherein the shoulder consists of flat planar surfaces that are all perpendicular to the inlet flow axis;
wherein all of a top facing of the arcuate slot consists of a flat planar surface that is perpendicular to the inlet flow axis; and
wherein a top facing of the arcuate slot is positioned axially above a top edge of the outlet.

While not wishing to be bound to any one benefit, one or more (or all) of the following benefits may be achieved: reduced messiness of spray; spray is more predictable and more greatly controlled regardless of the viscosities and pressure of the fluid (e.g., under various hot and cold conditions); the feed and flash at shut off surfaces is more balanced; spray aim and spray fan is cleaner and more stable; provide a near or at 0 degree spray aim; the spray avoids missing areas of the target surface; the spray avoids overspray; the spray avoids overlapping spray; a uniform spray distribution means is achieved, including and equal and optimized density of fluid per unit of surface area of the target; sufficient cleaning of the sensors to provide desired functionality and use in the overall system; less fluid is wasted fluid (that is there are less over cleaned high density areas in order to achieve a desired minimum level of cleaning in one or more low density areas); and/or potentially shorter duration cleaning cycles, meaning the sensor is performing its role for a longer time, less sensor blindness (both of the above could maximize the washer fluid reservoir's time-between-refills or minimize the size of a bottle to begin with); lower cost to produce, easier tooling of design, and the like.

The inventors initially demonstrated all of the aforementioned benefits of the disclosed embodiments for nozzles having up to a 5.00 mm major diameter. Subsequent testing suggests the geometry of the inner lumen up to at least two and a half times larger while retaining good performance. Notably, this expansion relates to the features influencing the fluid flow patterns (as discussed above), and it may not be necessary to scale up selected features, such as wall thickness, except as may be needed for sufficient structural strength. Therefore, the foregoing aspects need not be limited to extremely small sizes.

The described fluid spray nozzles may be made from any suitable material, including plastics, metals, and the like. The described fluid spray nozzles may be made from any suitable method, including tooling, injection molding, and the like. Significantly, the housing must be formed as a single piece, so as to avoid unwanted and unintended turbulent flow that can result from junctions, seams, and the like (although injection molded items can be configured so that any weld lines are accounted for by positioning them on the exterior and/or in alignment with expected fluid flow).

Although the disclosure has been described with reference to certain embodiments detailed herein, other embodiments can achieve the same or similar results. Variations and modifications of the disclosure will be obvious to those skilled in the art and the disclosure is intended to cover all such modifications and equivalents.

What is claimed is:

1. A one-piece, shear spray nozzle for a sensor cleaning system, the nozzle comprising:
a hollow cylindrical housing including an inlet that feeds a cavity and an outlet projecting a shear spray pattern at an angle relative to an inlet flow axis;
wherein the cavity includes a shoulder positioned next to an arcuate slot, with the outlet formed in a sidewall defining a portion of the arcuate slot; and
wherein the outlet is positioned above the shoulder.

2. The nozzle of claim 1 wherein the housing has a major diameter less than or equal to 5.00 mm and the outlet has a width that is between 5% and 25% of the major diameter.

3. The nozzle of claim 1 wherein the angle is perpendicular to the inlet flow axis.

4. The nozzle of claim 1 wherein the shoulder includes a first flat planar surface that is formed at an angle relative to the inlet flow axis.

5. The nozzle of claim 4 wherein the shoulder includes a second flat planar surface that is perpendicular to the inlet flow axis.

6. The nozzle of claim 5 wherein the arcuate slot is disposed radially between and axially above the first and second planar surfaces.

7. The nozzle of claim 1 wherein the outlet includes a stepped region formed outside of the cavity.

8. The nozzle of claim 7 wherein top and bottom planar surfaces are: i) connected to the outlet outside of the cavity, ii) define a portion of the stepped region, and iii) are positioned at non-perpendicular angles relative to the inlet flow axis.

9. The nozzle of claim 7 wherein a width of the stepped region is greater than a width of the outlet.

10. The nozzle of claim 1 wherein the arcuate slot includes a curved transition to a top wall is disposed at an opposite end of the arcuate slot in comparison to the outlet.

11. The nozzle of claim 1 wherein the arcuate slot has a generally triangular cross-sectional profile with the outlet disposed at a corner of the triangular profile and an opposing wall configured at a distance from the corner that produces a flat shear spray pattern in fluid expelled through the outlet.

12. The nozzle of claim 1 wherein the arcuate slot includes a protrusion that divides the arcuate slot into two separate chambers

13. The nozzle of claim 12 wherein the two separate chambers have identical dimensions.

14. The nozzle of claim 12 wherein the width of the protrusion is substantially similar to a width of the outlet.

15. The nozzle of claim 12 wherein the protrusion is radially spaced apart from the outlet at a distance that produces a flat shear spray pattern in fluid expelled through the outlet.

16. The nozzle of 1 wherein the shoulder is positioned at a different axial height in comparison to both the outlet and the arcuate slot.

17. The nozzle of claim 1 wherein the shoulder consists of flat planar surfaces that are all perpendicular to the inlet flow axis.

18. The nozzle of claim 1 wherein all of a top facing of the arcuate slot consists of a flat planar surface that is perpendicular to the inlet flow axis.

19. The nozzle of claim 1 wherein a top facing of the arcuate slot is positioned axially above a top edge of the outlet.
